(19) United States
(12) Patent Application Publication
(10) Pub. No.: US 2025/0174685 A1
(43) Pub. Date: May 29, 2025

(54) FUEL CELL SYSTEM

(71) Applicant: TOYOTA JIDOSHA KABUSHIKI KAISHA, Toyota-shi (JP)

(72) Inventors: Kento IDA, Nisshin-shi (JP); Jin ITO, Nagoya-shi (JP); Takuya IKEDA, Toyota-shi (JP); Tsuyoshi MARUO, Okazaki-shi (JP); Yusuke KAWASAKI, Takahama-shi (JP)

(21) Appl. No.: 18/948,733

(22) Filed: Nov. 15, 2024

(30) Foreign Application Priority Data
Nov. 28, 2023 (JP) 2023-200283

(51) Int. Cl. H01M 8/04223; H01M 8/04029; H01M 8/04225; H01M 8/04302; H01M 8/0432; H01M 8/04492; H01M 8/04664; H01M 8/04746

(52) U.S. Cl. CPC H01M 8/04253; H01M 8/04029; H01M 8/04225; H01M 8/04302; H01M 8/0432; H01M 8/04492; H01M 8/04664; H01M 8/04768

(57) ABSTRACT

To provide a fuel cell system capable of improving sub-zero startability of the fuel cell system. A fuel cell system, wherein the fuel cell system comprises a fuel cell stack, a cooling water pump, a temperature sensor, and a control device; wherein the fuel cell stack comprises stacked unit cells; wherein the cooling water pump is configured to circulate cooling water for cooling the fuel cell stack; wherein the temperature sensor is configured to measure an outside air temperature when starting the fuel cell system; wherein the control device is configured to determine a degree of deterioration of the unit cells; and wherein, when starting the fuel cell system below freezing point, the control device is configured to determine a time for stopping the cooling water pump according to a degree of deterioration of the unit cells.

### TECHNICAL FIELD

The present disclosure relates to a fuel cell system.

### BACKGROUND

Various studies have been proposed for fuel cells (FC) as disclosed in Patent Document 1.
Patent Document 1: Japanese Patent Application Laid-Open (JP-A) No. 2010-033975

Cooling water stop control is a measure for improving the startability of a fuel cell system at the time of start-up below freezing point. If the time for stopping the cooling water is too long, the catalyst and the like deteriorate due to abnormal temperature rise of the fuel cell. If the time for stopping the cooling water is too short, there is a possibility that the effect of improving the startability of the fuel cell system is not obtained, and the fuel cell system cannot be started. Therefore, it is necessary to appropriately determine the time for stopping the cooling water. On the other hand, in the case of commercial application of the fuel cell, as the total time of use of the fuel cell increases, the catalyst layer deteriorates and the sub-zero startability of the fuel cell system gradually decreases. Therefore, it is necessary to consider the degree of deterioration of the fuel cell in determining the time for stopping the cooling water.

Patent Document 1 discloses a fuel cell system in which generated water is prevented from freezing inside the fuel cell by stopping the cooling water pump for a predetermined period of time when the value of the temperature sensor is equal to or less than a predetermined temperature at the time of start-up below freezing point. When the time for stopping the cooling water pump is determined considering only the performance the fuel cell system had at the time of its production, the determined time is not applicable to the system subjected to durability deterioration. On the other hand, when the time for stopping the fuel cell system is determined in consideration of the post-durability deterioration of the fuel cell system and the determined time is applied at the time of initial start-up of the produced fuel cell system, there is a possibility that the fuel cell is overheated.

### SUMMARY

The disclosure was achieved in light of the above circumstances. An object of the disclosure is to provide a fuel cell system configured to improve sub-zero startability of the fuel cell system.

That is, the present disclosure includes the following embodiments.

<1> A fuel cell system,
wherein the fuel cell system comprises a fuel cell stack, a cooling water pump, a temperature sensor, and a control device;
wherein the fuel cell stack comprises stacked unit cells;
wherein the cooling water pump is configured to circulate cooling water for cooling the fuel cell stack;
wherein the temperature sensor is configured to measure an outside air temperature when starting the fuel cell system;
wherein the control device is configured to determine a degree of deterioration of the unit cells; and
wherein, when starting the fuel cell system below freezing point, the control device is configured to determine a time for stopping the cooling water pump according to a degree of deterioration of the unit cells.

<2> The fuel cell system according to <1>,
wherein the control device is configured to estimate a water content of the unit cells of the fuel cell stack not being in operation;
wherein, when the time for stopping the cooling water pump determined by the control device exceeds a predetermined time corresponding to the water content, the control device is configured to perform scavenging so that the estimated water content of the unit cells becomes smaller than the predetermined water content, when the operation of the fuel cell stack is stopped; and
wherein the predetermined time is the time of for stopping the cooling water pump, which causes abnormal overheating of the fuel cell stack.

The present disclosure can improve the sub-zero startability of the fuel cell system.

### BRIEF DESCRIPTION OF THE DRAWINGS

In the accompanying drawings,

FIG. 1 is a system configuration diagram illustrating an example of the fuel cell system of the present disclosure;

FIG. 2 is a graph showing a relationship between the number of unit cells deteriorated to a predetermined voltage or less and an allowable amount of generated water; and

FIG. 3 is a flowchart showing an exemplary control of the fuel cell system of the present disclosure.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the present specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like.

In the present disclosure, there is provided a fuel cell system,
wherein the fuel cell system comprises a fuel cell stack, a cooling water pump, a temperature sensor, and a control device;
wherein the fuel cell stack comprises stacked unit cells;
wherein the cooling water pump is configured to circulate cooling water for cooling the fuel cell stack;
wherein the temperature sensor is configured to measure an outside air temperature at the start of the fuel cell system;
wherein the control device is configured to determine a degree of deterioration of the unit cells; and
wherein, when at the time of sub-zero start of the fuel cell system, the control device is configured to determine a time for stopping the cooling water pump according to a degree of deterioration of the unit cells.

In the present disclosure, the time for stopping the cooling water pump (the criterion for integrating the amount of heat generated by the fuel cell) is changed in accordance with the deterioration of the fuel cell (the number of unit cells whose voltage has decreased to a predetermined value or less).

In the present disclosure, after the time for stopping the cooling water pump (the criterion of the integration of the heat generation values of the fuel cells) becomes long to the criterion of the overheating of the unit cells, the scavenging level at the time of stopping the operation of the fuel cell stack (the drainage water to the outside of the fuel cell system) is increased to reduce the water content of the plurality of unit cells at the time of starting the fuel cell system.

Accordingly, since the cooling water is not unnecessarily stopped, the deterioration of the electrolyte membrane, the catalyst, and the like due to abnormal overheating of the fuel cell and the deterioration of the separator due to the thermal strain generated when the cooling water is supplied from the cooling water stop state can be suppressed to a minimum, and the sub-zero startability can be ensured regardless of the degree of deterioration of the unit cell. Even in the case of commercial application of the fuel cell, it is possible to ensure the start-up property under the freezing point even after the durability of the fuel cell, while minimizing the durability input due to the stoppage of the cooling water.

Even in a condition in which the deterioration of the unit cell progresses and the cooling water stop time reaches the abnormal overheat threshold value of the fuel cell, the sub-zero startability of the fuel cell system can be ensured without causing the abnormal overheat.

Even in a condition where the deterioration of the battery has progressed by commercial application of the fuel cell, it is possible to ensure the sub-zero startability of the fuel cell system even after the fuel cell is durable without causing the fuel cell to overheat abnormally.

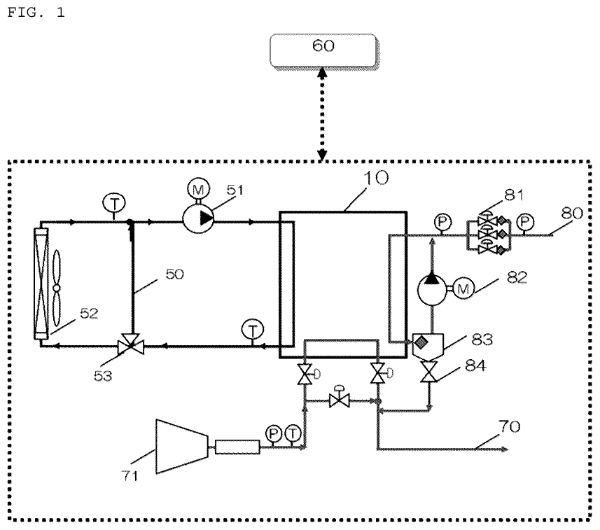

FIG. 1 is a system configuration diagram illustrating an example of the fuel cell system of the present disclosure.

The fuel cell system shown in FIG. 1 includes a fuel cell stack 10, a cooling system 50, a temperature sensor T, a control device 60, an oxidant gas system 70, and a fuel gas system 80. The cooling system 50 includes a cooling water pump 51, a radiator 52, a rotary valve 53, and the like. The oxidizing gas system 70 includes an air compressor 71, a pressure sensor P, a temperature sensor T, and the like. The fuel gas system 80 includes an injector 81, a fuel gas pump 82, a gas-liquid separator 83, an exhaust water discharge valve 84, a pressure sensor P, and the like.

The fuel cell system of the present disclosure may be mounted on a moving body such as a vehicle and used. Further, the fuel cell system of the present disclosure may be mounted in a stationary power generation system such as a generator that supplies electric power to the outside of the fuel cell system.

The vehicle may be a fuel cell vehicle or the like. Examples of the moving body other than the vehicle include a railway, a ship, and an aircraft.

Further, the fuel cell system of the present disclosure may be mounted on a moving body such as a vehicle capable of traveling even with electric power of a secondary battery.

The mobile body and the stationary power generation system may include the fuel cell system of the present disclosure. The moving body may include a drive unit such as a motor, an inverter, and a hybrid control system.

The hybrid control system may be capable of driving a moving body by using both the output of the fuel cell and the electric power of the secondary battery.

The fuel cell system includes a fuel cell that generates power by reacting hydrogen and oxygen, a fuel gas system that supplies a fuel gas containing hydrogen necessary for power generation of the fuel cell to the fuel cell, an oxidant gas system that supplies an oxidant gas containing oxygen to the fuel cell, and a cooling system that supplies cooling water that cools heat generated by power generation to the fuel cell.

The fuel cell system comprises a fuel cell stack.

A fuel cell stack is a stacked body in which a plurality of unit cells of a fuel cell are stacked.

In the present disclosure, both the battery and the fuel cell stack may be referred to as a fuel cell.

The number of stacked unit cells in the fuel cell stack is not particularly limited, and may be, for example, 2 to several hundred.

The fuel cell stack may include a current collector plate, a pressure plate, and the like at an end portion in the stacking direction.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are one anode (fuel electrode) and the other cathode (oxidant electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a fuel gas flow path on a surface on the side of the power generation unit.

The cathode separator may have a groove that serves as an oxidant gas flow path on a surface on the side of the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The cooling system supplies cooling water to the fuel cell stack as a cooling medium.

The cooling water may be water, ethylene glycol, or the like, or a mixture thereof.

The cooling system includes a cooling water pump, and may include a cooling flow path, a radiator, a bypass flow path, a rotary valve, a reserve tank, an ion exchanger, an intercooler, a temperature sensor, and the like, if necessary.

The cooling water pump circulates cooling water for cooling the fuel cell stack and adjusts a flow rate of the cooling water supplied to the fuel cell stack.

The cooling flow path is a flow path for circulating cooling water for cooling the fuel cell stack inside and outside the fuel cell stack.

The radiator is disposed on the cooling flow path.

The bypass flow path branches from the cooling flow path upstream of the radiator of the cooling flow path, bypasses the radiator, and merges with the cooling flow path downstream of the radiator of the cooling flow path.

The rotary valve is disposed at a branch point of the cooling flow path from the bypass flow path, and performs flow path switching to switch whether the cooling water discharged from the fuel cell stack flows to the radiator or flows to the bypass flow path. The rotary valve may include an electric motor such as an electric actuator for switching the flow path.

The temperature sensor of the cooling system measures the temperature of the cooling water.

The oxidizing gas system supplies an oxidizing gas to the fuel cell and adjusts a flow rate of the oxidizing gas. The oxidant gas system may include an oxidant gas supply device, an oxidant gas pipe, an inlet-side sealing valve at an oxidant gas inlet of the fuel cell, an outlet-side sealing valve at an oxidant gas outlet of the fuel cell, and the like.

The oxidant gas supply device may be an air compressor or the like.

The fuel gas system supplies fuel gas to the fuel cell and regulates a flow rate of the fuel gas.

The fuel gas system may include a fuel gas tank, a fuel gas inlet valve, an injector, a gas-liquid separator, an exhaust water valve, an ejector for circulating fuel gas, a fuel gas pump for circulating fuel gas, a fuel gas pipe, and the like.

The fuel cell system includes a temperature sensor.

The temperature sensor measures an outside air temperature when the fuel cell system is started.

The fuel cell system may include a secondary battery.

The secondary battery may be any battery that can be charged and discharged, and examples thereof include a nickel-hydrogen secondary battery and a conventionally known secondary battery such as a lithium-ion secondary battery. The secondary battery may include a power storage element such as an electric double layer capacitor. The secondary battery may have a configuration in which a plurality of the secondary batteries are connected in series. The secondary battery supplies electric power to an air compressor or the like. The secondary battery may be rechargeable from an external power source of the fuel cell system, such as a household power source. The secondary battery may be charged by the output of the fuel cell. The charging and discharging of the secondary battery may be controlled by the control device.

The fuel cell system may comprise a converter.

The fuel cell system includes a control device. The control device may control the entire fuel cell system by controlling the oxidant gas system, the fuel gas system, the cooling system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The controller determines a degree of deterioration of the plurality of unit cells.

At the sub-zero start of the fuel cell system, the control device determines a time (required cooling water stop time) for stopping the cooling water pump in accordance with a degree of deterioration of the plurality of unit cells.

The deterioration degree of the plurality of unit cells may be determined from the voltage of each unit cell or the voltage of the fuel cell stack, the average or maximum air stoichiometry during warm-up, and the like.

The fuel cell system may comprise a voltage sensor.

The voltage sensor may measure the voltage of each unit cell or the voltage of the fuel cell stack.

The controller may comprise a unit cell monitor for monitoring the voltage of each unit cell.

The control device may determine whether or not the voltage of each unit cell measured by the voltage sensor is equal to or lower than a predetermined voltage.

When the voltage of the unit cell measured by the voltage sensor is equal to or lower than the predetermined voltage, the control device may determine that the unit cell is deteriorated.

The required cooling water stop time determined by the control device may be a required cooling water stop time at the time of the next sub-zero start.

The controller may estimate the water content of the plurality of unit cells when the operation of the fuel cell stack is stopped.

When the time for stopping the cooling water pump determined by the control device exceeds a predetermined time (allowable cooling water stopping time) corresponding to the water content, the control device may perform scavenging so that the estimated water content of the plurality of unit cells becomes smaller than the predetermined water content (allowable generated water content) when the operation of the fuel cell stack is stopped. For example, the scavenging time may be longer than the normal scavenging time.

The predetermined time (allowable cooling water stop time) may be a stop time of the cooling water pump that causes abnormal overheating of the fuel cell stack.

The water content of the plurality of unit cells may be estimated by measuring the impedance of each unit cell. A data group indicating the relationship between the impedance of each unit cell and the water content may be prepared in advance, and the water content of each unit cell may be estimated by comparing the impedance of each unit cell with the data group.

The determination of the required cooling water stopping time at the time of the sub-zero start of the fuel cell system may be performed by the following method.

In the relation between the allowable generated water amount (g/unit cell) and the allowable cooling water stopping time (sec) or the allowable accumulated calorific value (kJ), if the stress (allowable generated water amount) is larger than the stress (allowable cooling water stopping time or allowable accumulated calorific value), the fuel cell system can be started under the freezing point.

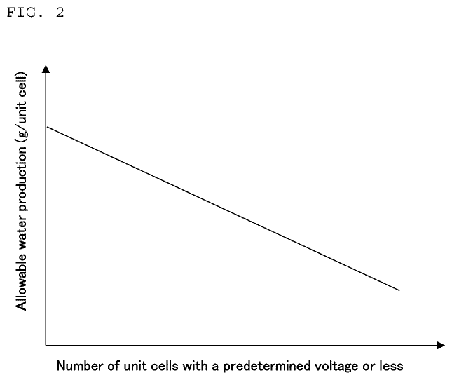

FIG. 2 is a graph showing a relationship between the number of unit cells deteriorated to a predetermined voltage or less and an allowable amount of generated water.

A second data group showing a relationship between the allowable generated water amount (g/unit cell) and the allowable coolant stopping time (sec) or the allowable accumulated heat generation amount (KJ), and a third data group showing a relationship between the number of unit cells below a predetermined voltage and the allowable generated water amount shown in FIG. 2 are prepared.

Then, a necessary cooling water stop time corresponding to the number of unit cells equal to or less than a predetermined voltage is determined in comparison with the second data group and the third data group, and a fourth data group indicating a relationship between the number of unit cells equal to or less than the predetermined voltage and the necessary cooling water stop time is prepared. According to the fourth data group, a required cooling water stop time corresponding to the number of unit cells equal to or less than a predetermined voltage at the time of start-up under freezing point is determined.

When the required cooling water stopping time determined from the number of unit cells equal to or lower than the predetermined voltage reaches the threshold ΔT (sec) of the allowable cooling water stopping time, which is the unit cell superheat criterion, the scavenging level at the time of stopping the operation of the fuel cell is strengthened, and the allowable generated water amount (strength) is increased.

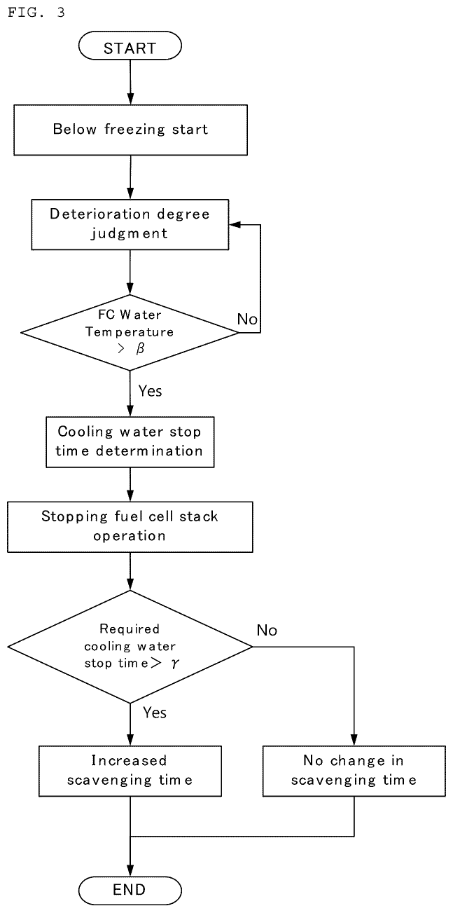

FIG. 3 is a flowchart showing an exemplary control of the fuel cell system of the present disclosure.

When the operation of the fuel cell system is started and the outside air temperature measured by the temperature sensor is below the freezing point, the control device warms up the fuel cell stack as a start below the freezing point.

During warm-up, the controller determines the degree of deterioration of the plurality of unit cells. Specifically, the number of unit cells equal to or lower than the predetermined voltage is counted.

When the temperature of the coolant (FC water temperature) of the fuel cell stack exceeds the predetermined temperature β, the warm-up is ended.

During the warm-up or after the end of the warm-up, the control device determines the time (required cooling water stop time) for stopping the cooling water pump at the time of the next start-up under the freezing point in accordance with the deterioration degree of the plurality of unit cells (the number of unit cells equal to or less than the predetermined voltage).

The controller estimates the water content of the plurality of unit cells when the operation of the fuel cell stack is stopped.

When the required cooling water stop time determined by the control device exceeds the predetermined time (allowable cooling water stop time) Y corresponding to the estimated water content of the plurality of unit cells, the control device performs scavenging by setting the scavenging time longer than the normal scavenging time so that the estimated water content of the plurality of unit cells becomes smaller than the predetermined water content (allowable generated water amount) when the operation of the fuel cell stack is stopped, and ends the control.

On the other hand, when the required cooling water stop time determined by the control device is within a predetermined time (allowable cooling water stop time) corresponding to the estimated water content of the plurality of unit cells, the control device performs scavenging by setting the scavenging time at the normal time when the operation of the fuel cell stack is stopped.

### REFERENCE SIGNS LIST

10. Fuel cell stack
50. Cooling system
51. Cooling water pump
52. Radiator
53. Rotary valve
60. Control device
70. Oxidant gas system
71. Air compressor
80. Fuel gas system
81. Injector
82. Fuel gas pump
83. Gas separator
84. Exhaust drain valve
P. pressure sensor
T. Temperature sensor

1. A fuel cell system,
wherein the fuel cell system comprises a fuel cell stack, a cooling water pump, a temperature sensor, and a control device;
wherein the fuel cell stack comprises stacked unit cells;
wherein the cooling water pump is configured to circulate cooling water for cooling the fuel cell stack;
wherein the temperature sensor is configured to measure an outside air temperature when starting the fuel cell system;
wherein the control device is configured to determine a degree of deterioration of the unit cells; and
wherein, when starting the fuel cell system below freezing point, the control device is configured to determine a time for stopping the cooling water pump according to a degree of deterioration of the unit cells.

2. The fuel cell system according to claim 1,
wherein the control device is configured to estimate a water content of the unit cells of the fuel cell stack not being in operation;
wherein, when the time for stopping the cooling water pump determined by the control device exceeds a predetermined time corresponding to the water content, the control device is configured to perform scavenging so that the estimated water content of the unit cells becomes smaller than the predetermined water content, when the operation of the fuel cell stack is stopped; and
wherein the predetermined time is the time for stopping the cooling water pump, which causes abnormal overheating of the fuel cell stack.
